(19) United States
(12) Patent Application Publication
(10) Pub. No.: US 2009/0189122 A1
(43) Pub. Date: Jul. 30, 2009

(54) METHOD FOR PREPARING OXIDE NANO PHOSPHORS

(75) Inventors: Tae-gon KIM, Seoul (KR); Dae-ho YOON, Suwon-si (KR); Takaki MASAKI, Otsu-shi (JP); Woo-jung PARK, Suwon-si (KR); Mong-Kwon JUNG, Hwaseong-si (KR); Seoung-jae IM, Seoul (KR)

Correspondence Address: CANTOR COLBURN, LLP, 20 Church Street, 22nd Floor, Hartford, CT, 06103, US

(73) Assignee: SAMSUNG ELECTRO-MECHANICS CO., LTD., Suwon-si (KR)

(21) Appl. No.: 12/129,241

(22) Filed: May 29, 2008

(30) Foreign Application Priority Data
Jan. 29, 2008 (KR) 10-2008-0008981

(51) Int. Cl. C09K 11/08

(52) U.S. Cl. 252/301.36

(57) ABSTRACT

Disclosed is a method for preparing an oxide nano phosphor. A metal precursor solution is prepared. The metal precursor solution is impregnated into a porous polymer material. A heat treatment is performed on the porous polymer material having the metal precursor solution impregnated therein. The heat treatment is performed by heating the porous polymer material having the metal precursor impregnated therein up to a temperature of higher than 500° C. solution at a temperature elevating rate of higher than 100° C. per minute.

This application claims priority to Korean Patent Application No. 10-2008-0008981, filed on Jan. 29, 2008, in the Korean Intellectual Property Office, and all the benefits accruing therefrom under 35 U.S.C. §119, the contents of which is incorporated herein in its entirety by reference.

### BACKGROUND OF THE INVENTION

1. Field of the Invention

The present invention relates to a method for preparing oxide nano phosphors, and more particularly, to a method for preparing oxide nano phosphors having a uniform particle size distribution.

2. Description of the Related Art

A phosphor is a material exhibiting luminescence characteristics by energy excitation. In general, the phosphor is used in various devices such as a light source, e.g. a mercury fluorescent lamp or a mercury-free fluorescent lamp, an electron emission device, a plasma display panel (PDP), and so on. Also, along with the development of new multimedia devices, phosphors are expected to be used in wide variety of applications in the future.

Nano phosphors, also referred to as nano-sized phosphors, advantageously exhibit a lower light scattering effect, compared to the conventional bulk-sized phosphors.

Requirements for nano phosphors include small particle size, separable property among particles, excellent luminescence efficiency, and so on. Phosphors made of small and well-separable particles usually exhibit a considerable reduction in the luminescence efficiency. To compensate for the reduction in the emission efficiency, many attempts have been made, for example, to raise a heating temperature or increase a heating time. Such attempts may, however, result in agglomeration of phosphor particles. That is, the dimension of the resulting phosphor may exceed a nano phosphor scale. Another disadvantage with the conventional technology is a prolonged period of processing, including mixing, drying, firing, pulverizing, and the like. To overcome these demerits in the art, various alternative methods, such as thermal spray and laser crystallization, have been proposed. However, these methods generally require high facility and operation costs, and involve difficulties in actual practice.

### SUMMARY OF THE INVENTION

The present invention provides a method for preparing an oxide nano phosphor having uniform particle size distribution.

The present invention also provides an oxide nano phosphor prepared by the method.

Disclosed is a method for preparing an oxide nano phosphor comprises: (a) preparing a metal precursor solution; (b) impregnating the metal precursor solution into a porous polymer material; and (c) performing a heat treatment on the porous polymer material having the metal precursor solution impregnated therein, wherein the heat treatment is performed by heating the porous polymer material having the metal precursor solution impregnated therein up to a temperature of about 500° C. or higher at a temperature elevating rate of about 100° C. or higher per minute.

According to an exemplary embodiment, the porous polymer material is a cellulose-based pulp.

Further disclosed is an oxide nano phosphor prepared by the above method.

### BRIEF DESCRIPTION OF THE DRAWINGS

The above and other features and advantages of the exemplary embodiments will be described in detail with reference to the accompanying drawings, in which:

FIG. 1 is a flow diagram schematically showing a method for preparing an oxide nano phosphor according to an exemplary embodiment of the present invention;

FIG. 2 is a graph illustrating changes in the temperature over time in a method according to an exemplary embodiment of the present invention and a general liquid-phase precursor technique; and

FIG. 3 is a graph illustrating thermogravimetric (TG) analysis and differential thermal analysis (DTA) of cellulose pulp;

FIG. 4 is a luminescence spectrum of a phosphor Y(P,V)O₄:Eu³⁺ excited at 254 nm;

FIG. 5 is a scanning electron microscope (SEM) image of an oxide nano phosphor described in Example 1;

FIG. 6 is a scanning electron microscope (SEM) image of an oxide nano phosphor described in Comparative Example 1;

FIG. 7 is a transmission electron microscopy (TEM) image of an oxide nano phosphor described in Example 1; and

FIG. 8 is a graph illustrating a particle size distribution of an oxide nano phosphor described in Example 1.

### DETAILED DESCRIPTION OF THE EXEMPLARY EMBODIMENTS

Disclosed embodiments will now be described more fully with reference to the accompanying drawings, in which exemplary embodiments are shown.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements and the thicknesses of layer and regions are exaggerated for clarity.

According to an exemplary embodiment, a method of preparing an oxide nano phosphor includes (a) preparing a metal precursor solution; (b) impregnating the metal precursor solution into a porous polymer material; and (c) performing a heat treatment on the porous polymer material having the metal precursor solution impregnated therein. In step (c), the heat treatment is performed by heating the porous polymer material having the metal precursor solution impregnated therein up to about 500° C. or higher at varying temperature elevating at about 100° C. or higher per minute.

In the exemplary embodiment, the porous polymer material is used as a template for forming precursor particles. Thus, the particles are heated at a high speed while sizes of initial particles are being extremely controlled, thereby synthesizing the oxide nano phosphor having a uniform particle size distribution of several tens to several hundreds nano meter sized particles while agglomeration thereof is being suppressed. The synthesized oxide nano phosphor can provide high luminescence efficiency as in bulk-form phosphors. In addition, the preparation method of the oxide nano phosphor according to the exemplary embodiment is simplified and economically advantageous without having to use expensive materials and facilities, compared to the conventional phosphor powder preparation method.

Further, the oxide nano phosphor prepared by the method according to the exemplary embodiment have a uniform particle size distribution, and provide excellent luminescence efficiency when they are used for illuminating or light-emitting devices.

The preparation method of the oxide nano phosphor according to an exemplary embodiment of the present invention will now be described.

First, metal precursor compound for forming phosphors is prepared and mixed with a solvent to give metal precursor compound solution. Here, the mixing may be performed by directly dissolving the metal precursor compound in the solvent. Acid or base may be used in dissolving the metal precursor compound in the solvent.

Examples of the metal precursor compound include carbonate, nitrate, chloride, hydroxide, oxalate, acetate, or oxide of Mg, Ca, Sr, Ba, Zn, Mn, Al, Ga, B, Y, Gd, Eu, Ce, Pr, Dy, Tm, Tb, Yb, Sm, Er, Bi, Sb, Ge, Si or Sn, tetraethylorthosilicate (TEOS), tetramethylorthosilicate (TMOS), H₃BO₃, NH₄B₅O₈, H₃PO₄, NH₄H₂PO₄, (NH₄)₂HPO₄, NH₄H₂PO₄, (NH₄)₃PO₄, VO(SO₄), Na₃VO₄, NaVO₃, NH₄VO₃, Na₂(NH₄)₄V₁₀O₂₈, or mixture of these materials.

A molar ratio of finally obtained oxide nano phosphor can be easily adjusted by adjusting an amount of the metal precursor compound added.

As the solvent of the metal precursor solution, water, methanol, ethanol, ethylene glycol, diethylene glycol, glycerol, or mixtures thereof can be used.

The preparation method according to the present invention can be applied to synthesis of various oxide phosphors, for example, (Gd,Y,Sc,Lu,La)BO₃:Eu³⁺, (Gd,Y,Sc,Lu,La)₂O₃:Eu³⁺, (Gd,Y,Sc,Lu,La)(P,V)O₄:Eu³⁺, (Ca,Sr,Ba)₂P₂O₇:Eu²⁺, Mn²⁺, (Ca,Sr,Ba)₅(PO₄)₃(Cl,F,Br,OH):Eu²⁺, Mn²⁺, ZnSiO₃:Mn²⁺, (Ca,Sr,Ba)MgAl₁₀O₁₇:Eu²⁺, Mn²⁺, (Ca,Sr,Ba)Al₂O₄:Eu²⁺, (Ca,Sr,Ba)BPO₅:Eu²⁺, Mn²⁺, Y₃Al₅O₁₂:Ce³⁺, (Ca,Sr,Ba)₂SiO₄:Eu²⁺, or (Ca,Sr,Ba)₃SiO₅:Eu²⁺. Examples of the metal precursor compound include YCl₃, VO(SO₄), H₃PO₄, EuCl₃, Na₃VO₄, H₃BO₃, Al(NO₃)₃, Sr(NO₃)₂, Ca(NO₃)₂, Ba(NO₃)₂, MgCl₂, CeCl₃, TbCl₃, tetraethylorthosilicate (TEOS), and so on.

The prepared metal precursor solution is impregnated into a porous polymer material.

The porous polymer material absorbs the metal precursor solution. The porous polymer material includes at least one matrix made of a material selected from amorphous or crystalline cellulose, wood, pulp, acetate and rayon cellophane. To prepare a finer polymer material, a material having a micro-cell structure, such as cellophane or wood, is used. For example, cellulose-based pulp having a micro-cell structure can be used.

In this embodiment, the metal precursor solution is impregnated into the porous polymer material to allow the metal precursor solution to be absorbed into micro-sized, polymeric pores, followed by drying the resultant product, thereby forming fine powder in the pores.

The pores contained in the micro-cell structure of the porous polymer material have an average diameter of about 20 nm or less. Since the pores having the metal precursor solution impregnated therein determines the particle size of final phosphor, the particle size of the nano phosphor can be controlled by the pore size of the porous polymer material.

When impregnating the metal precursor solution into the porous polymer material, a weight ratio of the metal precursor solution to the porous polymer material can be adjusted in various manners. According to an exemplary embodiment, the weight ratio of the metal precursor solution to the porous polymer material is about 1:1. Performing vacuum treatment when impregnating the metal precursor solution into the porous polymer material may facilitate absorption of the metal precursor solution into the micro-cell structure of the porous polymer material, thereby increasing the yield.

An excessive amount of the metal precursor solution is removed from the porous polymer material after the metal precursor solution is sufficiently impregnated therein. The excessive amount of the metal precursor solution present on a surface of the porous polymer material may result in precipitation of crystals or salt clusters after drying, which may adversely affect the uniform size distribution of phosphor powder. The excessive metal precursor solution can be removed using a compression means such as a centrifugal separator or a roller. The excessive metal precursor solution removed by the compression means may be recycled in the process of preparing the oxide nano phosphor.

The preparation method of the embodiment may have further drying the porous polymer material having the metal precursor solution impregnated therein after the excessive metal precursor solution is removed therefrom. The drying can be performed at about 25 to about 200° C. for about 5 to about 120 minutes. In the course of the drying, moisture is removed from the metal precursor solution impregnated into the porous polymer material, thereby giving metal precursor mixed powder.

Subsequently, the porous polymer material having the metal precursor solution impregnated therein is rapidly heated at varying temperature elevating at a rate of about 100° C. or higher per minute and undergoes heat treatment in a range of about 500 to about 1500° C. for about 10 minutes to about 3 hours. While performing the heat treatment, the porous polymer material is fired to vanish, and the metal precursor solution or the metal precursor solution compound powder existing in the micro-cell structure of the porous polymer material is oxidized to form oxide phosphors.

In the method of preparing an oxide nano phosphor, since the high-speed heat treatment allows the oxide nano phosphor to be synthesized before or while burning the porous polymer, particle sizes in the micro-cell structure of the porous polymer material can be maintained, thereby effectively preventing agglomeration of phosphor particles.

Throughout the description, the term “high-speed heat treatment” means a heat treatment being performed with a high rate of temperature elevation.

Various types of generally known electric heating devices can be used to perform the high-speed heat treatment, for example, a general heater, a radio frequency (RF) heater, a microwave heater.

The temperature during the heat treatment may vary according to the material used, that is, the types of the metal precursor compound and/or the porous polymer material. However, the porous polymer material is initially placed in a furnace at a temperature higher than an ignition temperature of the porous polymer material or a nucleation temperature of phosphor.

If an initial temperature for performing the heat treatment temperature is about 500° C. or higher, part of the porous polymer material may not be burnt, and nucleation may not occur properly, so that desired phosphors are not prepared.

According to an exemplary embodiment, the heat treatment can be performed at a temperature ranging from about 700 to about 1300° C.

An exemplary method of performing the high-speed heat treatment will now be described as follows. An electric heater is preheated at a temperature ranging from about 700 to about 1300° C., and temperature. Thus, the high-speed heat treatment can be performed on the materials with a high rate of temperature elevation.

In an exemplary embodiment, the heat treatment is performed for about 10 minutes to about 2 hours.

The product resulting from the porous polymer material having the metal precursor solution impregnated therein is rapidly placed into the electric heater maintained at the pre-heated heat treatment is subjected to a post-treatment, thereby obtaining a target oxide nano phosphor.

The post-treatment may include furnace-cooling from the temperature ranging from about 700 to about 1300° C., followed by pulverizing.

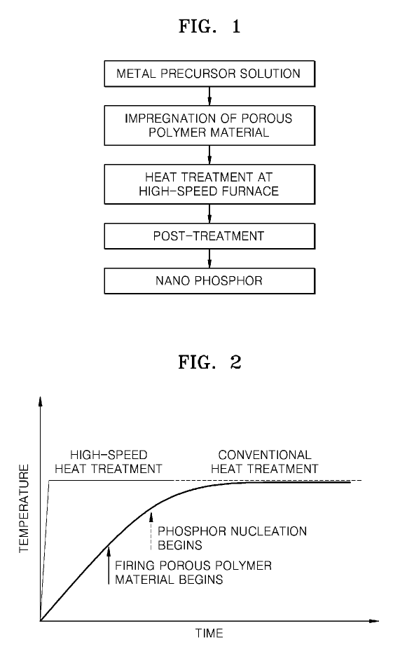

FIG. 1 is a flow diagram schematically showing a method for preparing an oxide nano phosphor according to an exemplary embodiment of the present invention.

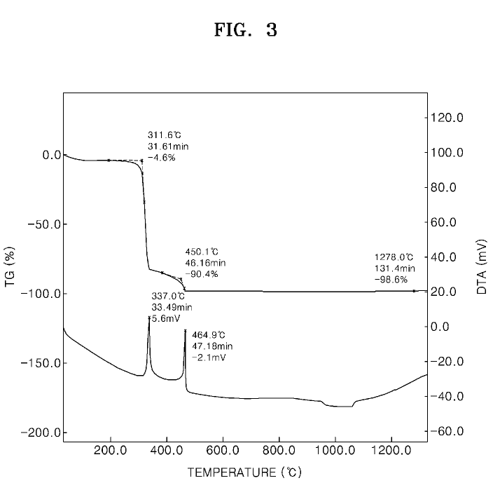

FIG. 2 is a graph illustrating changes in the temperature over time in a method according to an exemplary embodiment of the present invention and a general liquid-phase precursor technique. Referring to FIG. 2, according to the high-speed heat treatment of the present invention, burning of the porous polymer material and the nucleation of phosphor occur at substantially the same time period, while in case of a general liquid-phase precursor technique, firing and nucleation of the porous polymer material occur at different time periods.

FIG. 3 is a graph illustrating thermogravimetric (TG) analysis and differential thermal analysis (DTA) of cellulose pulp. Referring to FIG. 3, cellulose-based pulp is burnt at a temperature ranging from about 300 to about 500° C. The combustion energy from the burning may contributes to the preparation of phosphors.

An exemplary embodiment of the present invention includes an oxide nano phosphor prepared by the preparation method thereof.

Since the oxide nano phosphors prepared by the preparation method according to an exemplary embodiment of the present invention are nano-sized, agglomeration of phosphor particles is prevented efficiently in the preparation process of the phosphors, and uniformity of the particle size distribution can be achieved.

A difference between a D10 value and a D90 value of the oxide nano phosphors obtained is in the range of about 200 to about 1950 nm.

The D10 value denotes a diameter value where only 10 wt. % of phosphor particles has diameters smaller than the diameter value and the D90 value denotes a diameter value where 90 wt. % of phosphor particles has diameters smaller than the diameter value. The D10 and D90 values can be measured by conventional methods well known in the art, for example, transmission electron microscopy (TEM). Alternatively, the D10 and D90 values can also be measured using a measurement device, for example, a Zetamaster (Malvern Instruments Ltd, UK), and the measured values are analyzed to count the number of particles within each diameter distribution, thereby calculating the D10 and D90 values using the obtained data.

The particles of the oxide nano phosphor according to an exemplary embodiment of the present invention have, for example, a D10 value in a range of about 50 to about 400 nm and a D90 value in a range of about 600 to about 2000 nm.

The larger the difference between D10 and D90 values, the wider the particle diameter distribution of the oxide nano phosphor. On the other hand, the smaller the difference between D10 and D90 values, the narrower the particle diameter distribution of the oxide nano phosphor. Accordingly, if the difference between D10 and D90 values exceeds about 1950 nm, agglomeration of particles readily occurs, meaning that the oxide nano phosphor contains a large amount of particles having a large particle diameter, which is undesirable. If a difference between the D10 and D90 values is 0, the oxide nano phosphor will contain substantially the same particle size, which is, however, not practical. The oxide nano phosphor has a particle diameter difference between the D10 and D90 values of about 200 nm.

Further, the oxide nano phosphor has an average diameter in a range of about 100 to about 800 nm.

The nano phosphor according to the exemplary embodiments of the present invention are applicable in various fields including electroluminescence phosphors for various lighting or display devices, such as UV/Blue LED (Light Emission Diode), CCFL (Cold Cathode Fluorescent Lamp), PDP (Plasma Display Panel), FED (Field Emission Display), EL (Electroluminescence) device, and so on.

The exemplary embodiments of the present invention will be described in more detail with reference to the examples below. However these examples are for illustrative purposes only and are not intended to limit the scope of the invention.

### Example 1

30.15 g of 0.3M YCl₃.xH₂O aqueous solution, 9.38 g of 0.3M VO(SO₄).xH₂O aqueous solution, 1.37 g of H₃PO₄, and 1.68 g of 0.3M EuCl₃.xH₂O aqueous solution were mixed to obtain a transparent mixed solution. 10 g of (C₆H₁₀O₆)ₙ cellulose-based pulp was impregnated into 10 g of the transparent mixed solution for 3 hours, and an aqueous solution of surplus metallic salt was then removed from the resultant product, followed by drying at a temperature of about 90° C. for 1 hour. The pulp containing the metallic salt was placed into an electric heater whose temperature was elevated to 1150° C., and maintained at that temperature for 1 hour, followed by furnace-cooling. The obtained powder was pulverized in a mortar to acquire a target Y(P,V)O₄:Eu³⁺ nano phosphor.

### Comparative Example 1

30.15 g of 0.3M YCl₃.xH₂O aqueous solution, 9.38 g of 0.3M VO(SO₄).xH₂O aqueous solution, 1.37 g of H₃PO₄, and 1.68 g of 0.3M EuCl₃.xH₂O aqueous solution were mixed to obtain a transparent mixed solution. 10 g of (C₆H₁₀O₆)ₙ cellulose-based pulp was impregnated into 10 g of the transparent mixed solution for 3 hours, and an aqueous solution of surplus metallic salt was then removed from the resultant product, followed by drying at a temperature of about 90° C. for 1 hour. The pulp containing the metallic salt was placed into an electric heater whose temperature was elevated at a rate of 10° C./min for a time of 115 minutes until the temperature reached 1150° C., and maintained at that temperature for 1 hour, followed by furnace-cooling. The obtained powder was pulverized in a mortar to acquire a target Y(P,V)O₄:Eu³⁺ nano phosphor.

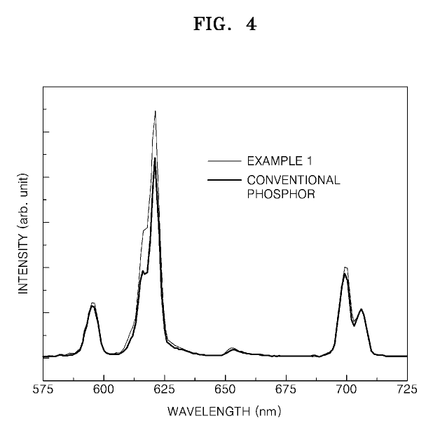

FIG. 4 is a graphical representation of luminescence spectra of Y(P,V)O₄:Eu³⁺ nano phosphor prepared in Example 1 and a general bulk phosphor, excited at 254 nm. As can be seen from FIG. 4, the nano phosphor prepared in Example 1 has better luminescence efficiency than the bulk phosphor.

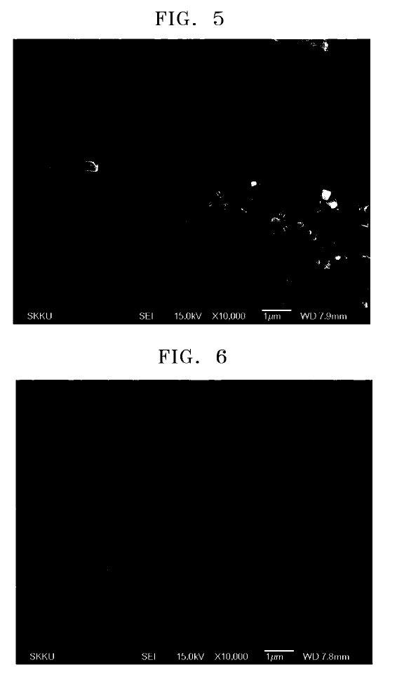

FIG. 5 is a scanning electron microscope (SEM) image of Y(P,V)O₄:Eu³⁺ nano phosphor prepared in Example 1.

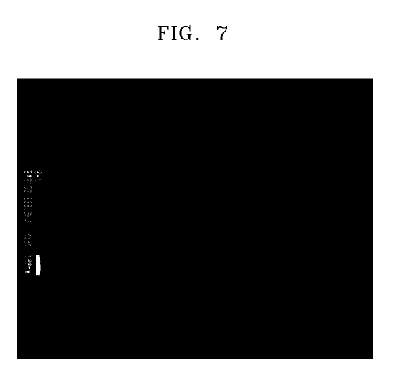

FIG. 6 is a scanning electron microscope (SEM) image of Y(P,V)O₄:Eu³⁺ nano phosphor prepared in Comparative Example 1.

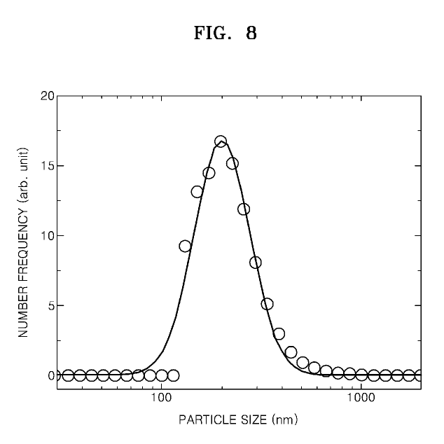

FIG. 7 is a transmission electron microscopy (TEM) image of Y(P,V)O₄:Eu³⁺ nano phosphor prepared in Example 1.

FIG. 8 is a graph illustrating a particle size distribution of Y(P,V)O₄:Eu³⁺ nano phosphor prepared in Example 1.

While disclosed embodiments has been shown and described with reference to exemplary embodiments thereof, it will be understood by those of ordinary skill in the art that various changes in form and details may be made therein without departing from the spirit and scope of the present invention as defined by the appended claims.

In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A method for preparing an oxide nano phosphor comprising:
(a) preparing a metal precursor solution;
(b) impregnating the metal precursor solution into a porous polymer material; and
(c) performing heat treatment on the porous polymer material having the metal precursor solution impregnated therein, wherein the heat treatment is performed by heating the porous polymer material having the metal precursor solution impregnated therein up to a temperature of about 500° C. or higher at a temperature elevating rate of about 100° C. or higher per minute.

2. The method of claim 1, wherein the porous polymer material includes at least one matrix made of a material selected from the group consisting of amorphous or crystalline cellulose, wood, pulp, acetate and rayon cellophane.

3. The method of claim 1, wherein the porous polymer material has pores having an average diameter of not greater than about 20 nm.

4. The method of claim 1, wherein the porous polymer material is a cellulose-based pulp.

5. The method of claim 1, wherein the metal precursor solution is prepared by mixing a metal precursor compound with a solvent.

6. The method of claim 5, wherein the solvent includes at least one selected from the group consisting of water, methanol, ethanol, ethylene glycol, diethylene glycol and glycerol.

7. The method of claim 5, wherein the metal precursor compound includes carbonate, nitrate, chloride, hydroxide, oxalate, acetate or oxide of Mg, Ca, Sr, Ba, Zn, Mn, Al, Ga, B, Y, Gd, Eu, Ce, Pr, Dy, Tm, Tb, Yb, Sm, Er, Bi, Sb, Ge, Si or Sn, tetraethylorthosilicate (TEOS), tetramethylorthosilicate (TMOS), H₃BO₃, NH₄B₅O₈, H₃PO₄, NH₄H₂PO₄, (NH₄)₂HPO₄, NH₄H₂PO₄, (NH₄)₃PO₄, VO(SO₄), Na₃VO₄, NaVO₃, NH₄VO₃ or Na₂(NH₄)₄V₁₀O₂₈, or a mixture of at least two materials thereof.

8. The method of claim 5, wherein the metal precursor compound is at least one selected from the group consisting of YCl₃, VO(SO₄), H₃PO₄, EuCl₃, Na₃VO₄, H₃BO₃, Al(NO₃)₃, Sr(NO₃)₂, Ca(NO₃)₂, Ba(NO₃)₂, MgCl₂, CeCl₃, TbCl₃ and tetraethylorthosilicate (TEOS).

9. The method of claim 1, wherein the heat treatment is performed by placing the porous polymer material impregnated with the metal precursor solution into an environment of a temperature ranging from about 500 to about 1500° C.

10. The method of claim 1, wherein the heat treatment is performed for about 10 minutes to about 3 hours.

11. The method of claim 1, before performing of the heat treatment, further comprising drying the porous polymer material having the metal precursor solution impregnated therein.

12. The method of claim 11, wherein the drying is performed at about 25 to about 200° C. for about 5 to about 120 minutes.

13. The method of claim 1, after performing of the heat-treatment, further comprising furnace-cooling followed by pulverizing the heat-treated product.

14. An oxide nano phosphor having an average particle diameter such that a difference between D10 value and D90 value is about 200 to about 1950 nm, wherein the D10 value denotes a diameter value where 10 wt. % of phosphor particles has diameters smaller than the diameter value and the D90 value denotes a diameter value where 90 wt. % of phosphor particles has diameters smaller than the diameter value.

15. The oxide nano phosphor of claim 14, wherein the oxide nano phosphor is used for illuminating or display devices.
